(19) United States
(12) Patent Application Publication
(10) Pub. No.: US 2024/0399618 A1
(43) Pub. Date: Dec. 5, 2024

(54) Three dimensional printer

(71) Applicant: Winsun Technology INC, Irvine, CA (US)

(72) Inventor: Yihe MA, Irvine, CA (US)

(73) Assignee: Winsun technology INC., Irvine, CA (US)

(21) Appl. No.: 18/327,824

(22) Filed: Jun. 1, 2023

(51) Int. Cl. B28B 1/00; B33Y 10/00; B33Y 30/00

(52) U.S. Cl. CPC B28B 1/001; B33Y 10/00; B33Y 30/00

(57) ABSTRACT

The utility model relates to the technical field of 3D printing, in particular to a 3D printer. The 3D printer comprises a first working head and a support system. Wherein the support system comprises an X-direction movement mechanism, a Y-direction movement mechanism and a Z-direction movement mechanism, the Z-direction movement mechanism comprises two sets of oppositely-arranged Z-direction movement assemblies, each Z-direction movement assembly comprises a plurality of Z-direction movement members, the Z-direction movement members are arranged in parallel at intervals, and each Z-direction movement member comprises a plurality of first brackets connected end to end along the Z direction; the length of the Z-direction moving member can be achieved by connecting the preset number of first brackets, allowing for the connection of Z-axis movers with unlimited length, This expands the height range of buildings that this 3D printer can print, thereby broadening the applicability of the 3D printer.

### TECHNICAL FIELD

The present invention relates to the field of 3D printing, more particularly, to a 3D printer.

### BACKGROUND

Currently, 3D printers are becoming increasingly widespread in the field of construction, especially in the application of large buildings.

A 3D printer comprises a support system and a print head. The support system comprises an X-direction movement mechanism, a Y-direction movement mechanism, and a Z-direction movement mechanism. The Y-direction movement mechanism can be movably arranged on the Z-direction movement mechanism, the X-direction movement mechanism can be movably arranged on the Y-direction movement mechanism, and the print head can be movably arranged on the X-direction movement mechanism. This allows the print head to move along the X, Y, and Z directions on the support system, making it easy to flexibly print complex architectural structures.

However, the length of the Z-direction movement mechanism of the support system of the existing 3D printer is limited and cannot realize unlimited extension in the Z direction, resulting in a limited height of the building that the 3D printer can print.

In order to solve the above problems, there is an urgent need to provide a 3D printer that solves the problem of the limited length of the Z-direction movement mechanism and the inability to achieve unlimited extension in the Z direction.”

### SUMMARY OF THE INVENTION

The objective of this invention is to propose a 3D printer, in which the Z-direction movement mechanism can be extended indefinitely in length. This is beneficial for processing, assembly, and is cost-effective.

To achieve this, the invention adopts the following technical plan:

A 3D printer is proposed, comprising a first working head and a support system. The support system comprises the following.
An X-direction movement mechanism, configured to drive the first working head to move along the X-direction;
A Y-direction movement mechanism, configured to drive the X-direction movement mechanism to move along the Y-direction; and
A Z-direction movement mechanism is configured to drive the Y-direction movement mechanism to move along the Z-direction. This mechanism comprises two groups of Z-direction movement assemblys arranged in opposition. Each Z-direction movement assembly comprises multiple Z-direction movement members, which are parallel and spaced apart. Each Z-direction movement member consists of a number of first brackets connected end-to-end along the Z-direction.

As an optional embodiment, the first brackets can be detachably connected between adjacent ones.

As another optional embodiment, the first brackets are made of carbon steel profiles.

In yet another optional embodiment, the X-direction movement mechanism comprises an X-direction movement assembly, which is set at the output end of the Y-direction movement mechanism. This X-direction movement assembly comprises multiple second brackets connected end to end.

As an optional embodiment, the second brackets can be made of aluminum alloy profiles.

In another optional embodiment, the X-direction movement assembly is at least two sets.

The 3D printer further comprises at least two second working heads. The first working head is provided on one group of the X-direction movement assemblies. On each X-direction movement assembly not having the first working head, at least one second working head is provided.

As an optional embodiment, the first working head can be a print head, and the second working head can be a head for modifying windows and doors, applying putty, or spray painting.

As another optional embodiment, the Y-direction movement mechanism comprises
two groups of Y-direction movement assemblies. These are respectively provided on the two groups of Z-direction movement assemblies, and the Y-direction movement assemblies comprise multiple second brackets that can be detachably connected end to end.

As an optional embodiment, the Z-direction movement mechanism also comprises a Z-direction drive assembly. This drive assembly comprises
a drive member, which is set on the Y-direction movement mechanism;
a gear, which is set at the output end of the drive member; and
a rack, which is set along the Z-direction on the Z-direction movement member, and the gear meshes with the rack.

As another optional embodiment, the Z-direction movement mechanism further comprises
at least one group of guiding assemblies. These are set on the Z-direction movement member. The guiding assemblies are configured to provide guidance for the Y-direction movement mechanism to move along the Z-direction.

The beneficial effects of this utility application are as follows:

This utility application provides a 3D printer with a first working head and a support system. The support system comprises X, Y, and Z-direction movement mechanisms. The X-direction movement mechanism can drive the first working head to move along the X-direction, the Y-direction movement mechanism can drive the X-direction movement mechanism to move along the Y-direction, and the Z-direction movement mechanism can drive the Y-direction movement mechanism to move along the Z-direction. The Z-direction movement mechanism comprises two groups of Z-direction movement assemblys arranged in opposition. Each Z-direction movement assembly comprises multiple Z-direction movement members, which are parallel and spaced apart. Each Z-direction movement member consists of multiple first brackets connected end-to-end along the Z-direction. The length of the Z-direction movement member can be achieved by connecting a preset number of first brackets. An operator can set the number of first brackets according to the needs of the building, achieving the connection of Z-direction movement members with unlimited length. This expands the height range of buildings that this 3D printer can print, thereby broadening the applicability of the 3D printer. For example, by connecting multiple first brackets end to end, the Z-direction movement member can reach a height of more than 50 meters. At the same time, the segmented structure of the Z-direction movement member helps reduce the processing costs of large-sized structures. The shorter first brackets are easy to transport and flexible to assemble, which is beneficial for improving work efficiency.

### BRIEF DESCRIPTION OF THE DRAWINGS

To clarify the technical solutions in the embodiments of this utility application, the following is a brief introduction to the diagrams required in the description of the utility applications embodiments. It's clear that the diagrams described below are merely a few embodiments of this utility application. For those of ordinary skilled in the art, without the need for creative effort, other diagrams can be derived from the content of the utility applications embodiments and these diagrams.

FIG. 1 is a structural schematic illustration of a 3D printer provided in an embodiment of the present invention;

FIG. 2 is a second structural schematic of the 3D printer provided in an embodiment of the present invention;

FIG. 3 is a partial enlarged view at location A in FIG. 2;

FIG. 4 is a partial enlarged view at location C in FIG. 1;

FIG. 5 is a partial enlarged view at location B in FIG. 1.

The labels in the figures are as follows:
100—first working head;
200—support system; 210—X-direction movement mechanism; 211—X-direction movement assembly; 2111—second bracket; 212—X-direction drive assembly; 213—third guide assembly; 220—Y-direction movement mechanism; 221—Y-direction movement assembly; 222—Y-direction drive assembly; 223—second guide assembly; 230—Z-direction movement mechanism; 231—Z-direction movement assembly; 2311—Z-direction movement member; 2311a—first bracket; 232—Z-direction drive assembly; 2321—drive member; 2322—gear; 2323—rack; 233—first guide assembly; 2331—guide rail; 2332—movement member;
300—second working head.

### DESCRIPTION OF EMBODIMENTS

The following is a further detailed explanation of this utility application in conjunction with the drawings and embodiments. It can be understood that the specific embodiments described here are only used to explain this utility application and do not limit its scope. Furthermore, it should be noted that, for the sake of simplicity, only the part of the structure related to this utility application, not the entire structure, is shown in the figures.

In the description of this utility application, unless there are explicit definitions and restrictions, terms like “connected”, “connection”, and “fixed” should be understood broadly. For example, they could refer to a fixed connection or a detachable connection, or being integral; they can be mechanical or electrical connections; they can be directly connected, or indirectly connected through an intermediary medium, and it can refer to a communication within the structure of two elements or the interactive relationship between two elements. Those of ordinary skill in the art can understand the specific meaning of these terms in this utility application according to the specific circumstances.

In this utility application, unless there are explicit definitions and restrictions, the term “above” or “below” of the first feature relative to the second feature may include direct contact between the first and second features, or include that the first and second features are not in direct contact but are in contact through another feature between them. Moreover, the terms “above”, “over” and “on” of the first feature relative to the second feature include the first feature being directly above and obliquely above the second feature, or simply indicating that the horizontal height of the first feature is higher than the second feature. The terms “below”, “under”, and “beneath” of the first feature relative to the second feature include the first feature being directly below and obliquely below the second feature, or simply indicating that the horizontal height of the first feature is lower than the second feature.

In the description of this embodiment, terms such as “up”, “down”, “left”, “right”, etc., are based on the orientation or positional relationship shown in the figures, which are only for convenience of description and simplification of operation, and do not indicate or imply that the device or assembly in question must have a specific orientation, or be constructed and operated in a specific orientation, thus it should not be understood as a limitation of this utility application. In addition, terms like “first”, “second” are merely used for distinction in the description and do not have any special significance.

Currently, 3D printers are increasingly being applied in the field of architecture, particularly in large-scale buildings.

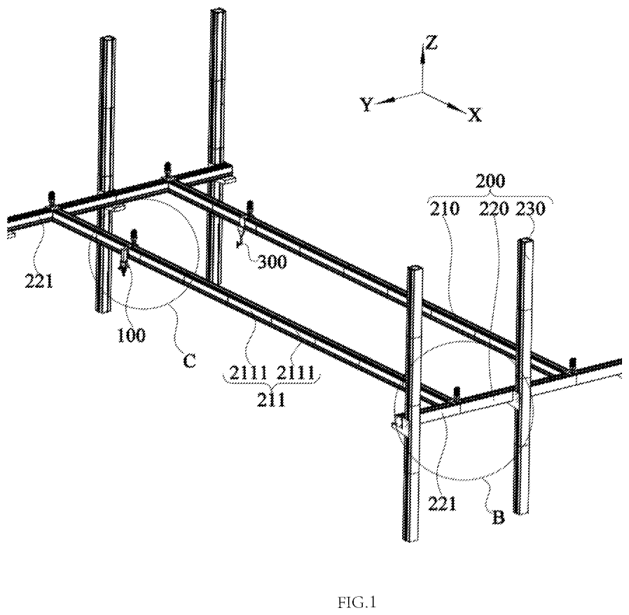

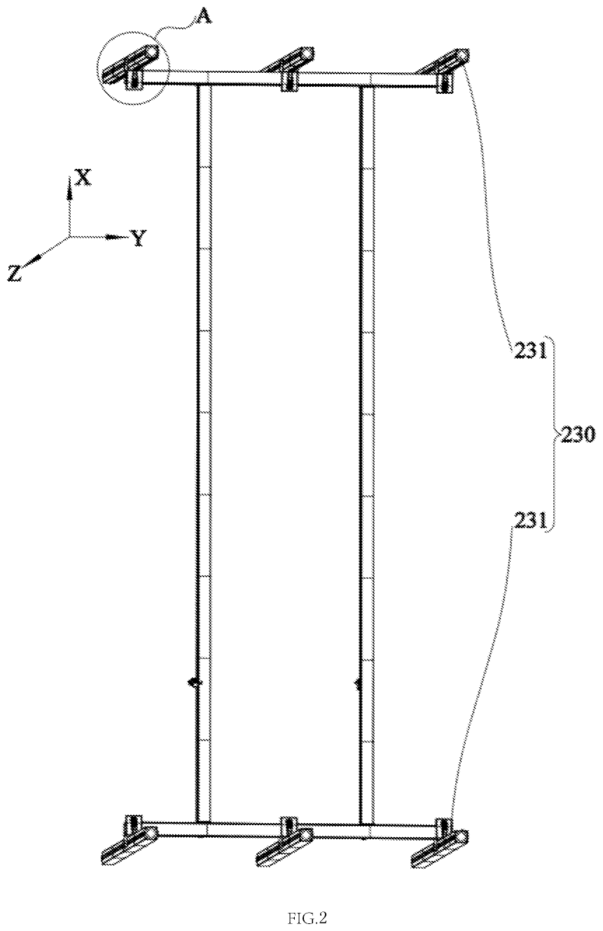

As shown in FIGS. 1 and 2, this embodiment provides a 3D printer, which comprises a first working head 100 and a support system 200. The first working head 100 is a print head, used for extruding paste to print structures like the walls of a building. The support system 200 comprises an X-direction movement mechanism 210, a Y-direction movement mechanism 220, and a Z-direction movement mechanism 230. The X-direction movement mechanism 210 can drive the print head to move in the X direction, the Y-direction movement mechanism 220 can drive the X-direction movement mechanism 210 to move in the Y direction, and the Z-direction movement mechanism 230 can drive the Y-direction movement mechanism 220 to move in the Z direction, thus allowing the print head to move in the X, Y, and Z directions on the support system 200. This facilitates the print head to flexibly print complex architectural structures, which is beneficial for expanding the applicable range of this 3D printer.

In reference to FIGS. 1 to 3, the detailed structure of the Z-direction movement mechanism 230 is explained below.

As shown in FIGS. 1 to 3, the Z-direction movement mechanism 230 comprises two sets of oppositely arranged Z-direction movement assemblies 231. Each Z-direction movement assembly 231 comprises multiple Z-direction movement members 2311, which are parallel and spaced apart, and each Z-direction movement member 2311 comprises multiple first brackets 2311a that are connected end-to-end along the Z direction. The length of the Z-direction movement member 2311 can be achieved by connecting a preset number of first brackets 2311a. Operators can set the number of first brackets 2311a according to the requirements of the building, which can achieve an infinite length connection of the Z-direction movement member 2311, expand the height range of the building that the 3D printer can print, and thus expand the applicable range of the 3D printer. For example, by connecting multiple first brackets 2311a end to end, the Z-direction movement member 2311 can reach a height of more than 50 meters.

In this embodiment, each set of Z-direction movement assemblies 231 comprises three Z-direction movement members 2311, which are parallel and spaced apart. This is beneficial for improving the stability of the support for the Y-direction movement mechanism 220 and for expanding the travel range of the Y-direction movement mechanism 220, thereby increasing the working travel of the 3D printer in the Y direction, which is beneficial for expanding the applicable range of this 3D printer.

At the same time, the segmented structure of the Z-direction movement member 2311 helps to reduce the processing cost of large-size structures, and the shorter first bracket 2311a is easy to transport and flexible to assemble, which is beneficial for improving work efficiency and the flexibility and quality of the support system 200.

Furthermore, because 3D printers used in the field of architecture need to change construction sites according to building requirements, and the long Z-direction movement mechanism 230 is not convenient for storage or transport. To solve this problem, the first brackets 2311a can be detachably connected to each other. After the printing is completed, the operator can disassemble the Z-direction movement member 2332 for storage or transport, which is convenient for storage or transport and can help reduce storage or transport costs.

Due to the large length of the Z-direction movement member 2311, to ensure the precision and accuracy of the print head moving in the Z direction, the first bracket 2311a is made of carbon steel profile. Carbon steel profile has high strength and bending resistance, which can meet the strength requirements of the 3D printer in the Z direction. Meanwhile, the surface of the carbon steel profile is painted, which is beneficial to improve the rust prevention effect and aesthetics of the Z-direction movement mechanism 230.

Further, a wall tension rod is set in the Z-direction movement mechanism 230 to improve the rigidity of the support system 200 in the Z direction, especially the rigidity requirements when the height of the Z-direction movement member 2311 exceeds 12 meters.

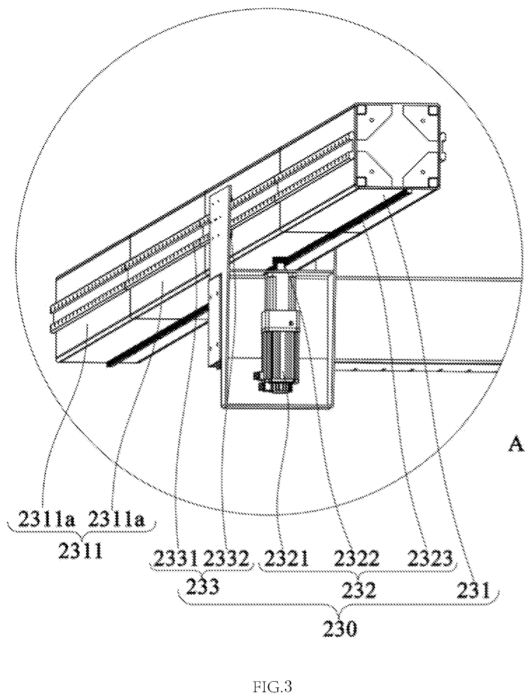

As can be understood, as shown in FIG. 3, the Z-direction movement mechanism 230 also comprises a Z-direction drive assembly 232. The Z-direction drive assembly 232 can drive the Y-direction movement mechanism 220 to move in the Z direction. Specifically, the Z-direction drive assembly 232 comprises a drive member 2321, a gear 2322, and a rack 2323. The drive member 2321 is set on the Y-direction movement mechanism 220, the gear 2322 is set on the output end of the drive member 2321, and the rack 2323 is set on the Z-direction movement member 2311 along the Z direction, and the gear 2322 meshes with the rack 2323, which is beneficial to ensure the stability and accuracy of the Y-direction movement mechanism 220 moving in the Z direction. Specifically, both ends of each Y-direction movement assembly 221 of the Y-direction movement mechanism 220 are equipped with drive members 2321, which drive the gear 2322 to move on the rack 2323, so as to realize the movement of the Y-direction movement mechanism 220 on the Z-direction movement mechanism 230 in the Z direction.

Further, as shown in FIG. 3, the Z-direction movement mechanism 230 also comprises at least one group of first guide assembly 233, set on the Z-direction movement member 2311. The first guide assembly 233 is configured to provide guidance for the Y-direction movement mechanism 220 to move in the Z direction, so as to improve the stability of the Y-direction movement mechanism 220 moving in the Z direction. For example, the first guide assembly 233 can be one group, two groups or three groups, each group of first guide assembly 233 are set parallel to each other to further improve the movement precision and stability of the Y-direction movement mechanism 220. In this embodiment, the first guide assembly 233 is two groups, and the two groups of first guide assembly 233 are respectively set on two opposite sides of the Z-direction movement member 2311, which is beneficial to avoid interference between the two groups of first guide assembly 233 and facilitate assembly and maintenance.

Specifically, the first guide assembly 233 comprises a guide rail 2331 and a guide member. The guide rail 2331 is set on the Z-direction movement member 2311 along the Z direction. The guide member slides or rolls with the guide rail 2331 to improve the movement precision and stability of the Y-direction movement mechanism 220 and avoid jamming during the movement process of the Y-direction movement mechanism 220. For example, the movement member 2332 is a roller, which provides guidance and support for the movement of the Y-direction movement mechanism 220 by rolling on the guide rail 2331. This helps to enhance the stability of the movement of the Y-direction movement mechanism 220, avoid jamming during movement, and thus improve the smoothness of the movement of the print head along the Z-axis. In this example, there are two sets of rollers, which are respectively set on both sides of the guide rail 2331, and multiple rollers are set on each side. Of course, in other embodiments, the movement member 2332 could also be a slider that provides guidance for the movement of the first mounting bracket by slidingly connecting with the first guide rail 2331.

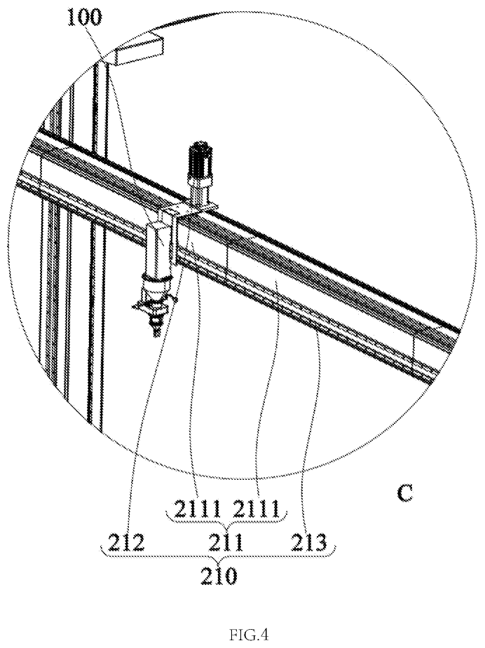

In reference to FIGS. 1 and 4, the detailed structure of the Y-direction movement mechanism 220 is explained below.

As shown in FIGS. 1 and 4, the Y-direction movement mechanism 220 comprises two sets of Y-direction movement assembly 221, which are respectively set on two sets of Z-direction movement assembly 231. Moreover, the Y-direction movement assembly 221 include several detachable second brackets 2111. The length of the Y-direction movement member 2332 can be achieved by connecting a predetermined number of the second brackets 2111. The operator can adjust the number of the second brackets 2111 based on the requirements of the building. This allows for the increase or decrease in the length of the Y-direction movement member 2332, thereby meeting different size requirements, improving the flexibility of the bracket mechanism, expanding the range of building sizes that this 3D printer can print along the Y-direction, and thus expanding the applicability of the 3D printer. The detachable connection method also facilitates installation and transportation.

Further, the second bracket 2111 is made of aluminum alloy profile, which can meet the strength requirements of the Y-direction length, as well as help reduce the weight of the bracket system 200, achieving a lightweight overall structure.

It is understood that as shown in FIGS. 1 and 4, the Y-direction movement mechanism 220 also comprises a Y-direction drive assembly 222 and a second guide assembly 223. Specifically, the Y-direction movement assembly 221 is set at both ends of the Z-direction movement mechanism 230, capable of driving the X-direction movement mechanism 210 to move along the Y-direction on the Y-direction movement assembly 221. The Y-direction drive assembly 222 and the second guide assembly 223 are the same as the Z-direction drive assembly 232 and the first guide assembly 233 of the Z-direction movement mechanism 230, which are not further elaborated here.

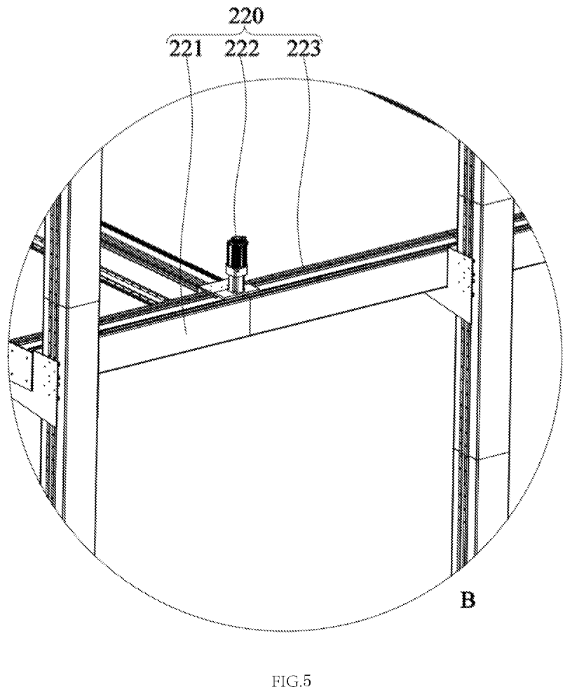

In reference to FIGS. 1 and 5, the detailed structure of the X-direction movement mechanism 210 is explained.

As shown in FIGS. 1 and 5, the X-direction movement mechanism 210 comprises an X-direction movement assembly 211, which is set at the output end of the Y-direction movement mechanism 220. The X-direction movement assembly 211 comprises several interconnected second brackets 2111. The operator can adjust the number of the second brackets 2111 of the X-direction movement assembly 211 based on the requirements of the building, allowing for an increase or decrease in the length of the X-direction movement member 2332. This accommodates different size requirements, enhances the flexibility of the bracket mechanism, expands the range of building sizes that this 3D printer can print along the X-direction, and thus widens the applicability of the 3D printer. The detachable connection method also facilitates installation and transportation.

Furthermore, as shown in FIG. 1, there are at least two sets of X-direction movement assembly 211. The 3D printer also comprises at least two second work heads 300. The print head is set on one set of the X-direction movement assembly 211, and each X-direction movement assembly 211 not equipped with a print head is set with at least one second work head 300. This enables the print head and the second work heads 300 to run simultaneously, enhancing the work efficiency of the 3D printer.

Specifically, the second work head 300 may be a door and window repair head, plaster head, or paint spraying head. When the print head is printing structures like building walls, the second work head 300 can simultaneously perform door and window repairs, plastering, or wall painting. This not only improves the work efficiency of the 3D printer but also allows operators to select according to the specific structural requirements of the building, enhancing the flexibility of the 3D printer.

It is understood that, as shown in FIGS. 1 and 5, the X-direction movement mechanism 210 also comprises an X-direction drive assembly 212 and a third guide assembly 213. Specifically, the X-direction movement assembly 211 is set between the print head or second work head 300 and the X-direction movement assembly 211, capable of driving the print head or second work head 300 to move along the X-direction on the X-direction movement assembly 211. And the X-direction drive assembly 212 and the third guide assembly 213 are the same as the Z-direction drive assembly 232 and the first guide assembly 233 of the Z-direction movement mechanism 230, which are not further elaborated here.

The above shows and describes the basic principles, main features, and advantages of this utility model. Technical personnel in this field should understand that this utility model is not limited by the above implementation methods. The implementation methods and descriptions in the instructions are only used to illustrate the principles of this utility model. Without deviating from the spirit and scope of this utility model, various changes and improvements will be made to this utility model, all of which fall within the scope of protection required by this utility model. The scope of protection required by this utility model is defined by the attached claims and their equivalents.”

1. A 3D printer for printing a building, comprising:
a first working head (100) and a support system (200), and said support system (200), comprising:
an X-direction movement mechanism (210), said X-direction movement mechanism (210) is configured to drive the first working head (100) to move in the X direction;
a Y-direction movement mechanism (220), said Y-direction movement mechanism (220) is configured to drive the X-direction movement mechanism (210) to move in the Y direction; and
a Z-direction movement mechanism (230), said Z-direction movement mechanism (230) is configured to drive the Y-direction movement mechanism (220) to move in the Z direction. The Z-direction movement mechanism (230) includes two groups of oppositely arranged Z-direction movement components (231), said Z-direction movement components (231) include multiple Z-direction moving members (2311), multiple Z-direction moving members (2311) are set in parallel and at intervals, and each Z-direction moving member (2311) includes multiple first brackets (2311a) connected end to end along the Z direction.

2. The 3D printer according to claim 1, characterized in that adjacent first brackets (2311a) are detachably connected.

3. The 3D printer according to claim 1, characterized in that the first bracket (2311a) is made of carbon steel profile.

4. The 3D printer according to claim 1, characterized in that the X-direction movement mechanism (210) comprises: an X-direction movement assembly (211), said X-direction movement assembly (211) is set at an output end of the Y-direction movement mechanism (220), and the X-direction movement assembly (211) comprises a plurality of second brackets (2111) connected end to end.

5. The 3D printer according to claim 4, characterized in that a second bracket (2111) is made of aluminum alloy profile.

6. The 3D printer according to claim 4, characterized in that
there are at least two groups of the X-direction movement assembly (211), and the 3D printer further comprises at least two second working heads (300), the first working head (100) is set on one group of the X-direction movement assemblies (211), and for each X-direction movement assembly (211) not equipped with the first working head (100), at least one second working head (300) is set.

7. The 3D printer according to claim 6, characterized in that the first working head (100) is a printing head, and the second working head (300) is a window and door trimming head, a putty spreading head, or a spray-painting head.”

8. The 3D printer according to claim 7, characterized in that the Y-direction movement mechanism (220) includes: two groups of Y-direction movement assemblies (221), the two groups of Y-direction movement assemblies (221) are respectively arranged on the two groups of Z-direction movement assemblies (231), and the Y-direction movement assembly (221) includes a plurality of second brackets (2111) that can be detachably connected end to end.

9. The 3D printer according to claim 7, characterized in that the Z-direction movement mechanism (230) further comprises a Z-direction drive assembly (232), the Z-direction drive assembly (232) comprises: a drive member (2321), arranged on the Y-direction movement mechanism (220); a gear (2322), arranged at the output end of the drive member (2321); and a rack (2323), arranged along the Z-direction on the Z-direction moving member (2311), and the gear (2322) meshes with the rack (2323).

10. The 3D printer according to claim 1, characterized in that the Z-direction movement mechanism (230) further comprises: at least one group of guiding assemblies (233), arranged on the Z-direction moving member (2311), the guiding assembly (233) is configured to provide guidance for the Y-direction movement mechanism (220) to move in the Z direction.

11. A method of printing a large-scale building, comprising
printing an architecture higher than 10 meters, comprising:
providing a 3D printer, comprising a working head and a support system,
wherein the first working head is a printing head; the support system 200 comprises an X-direction movement mechanism 210, a Y-direction movement mechanism 220, and a Z-direction movement mechanism 230;
allowing the print head to print the architecture, comprising:
driving the printing head to move in a X direction by the X-direction movement mechanism 210; drive the X-direction movement mechanism 210 to move in the Y direction by the Y-direction movement mechanism 220; and drive the Y-direction movement mechanism 220 to move in the Z direction by the Z-direction movement mechanism 230;
arranging two of oppositely arranged Z-direction movement assemblies 231, each Z-direction movement assemblies comprises multiple Z-direction movement members 2311, and each Z-direction movement member 2311 further comprises multiple first brackets 2311a that are connected end-to-end along the Z direction;
determining a number of first brackets 2311a according to a requirement of the architecture, connecting the number of first brackets 2311a
improving rigidity of the support system 200 in the Z direction by using a wall tension rod in the in the Z-direction movement mechanism 230;
ensuring stability and accuracy of the Y-direction movement mechanism 220 moving in the Z direction, by
providing Z-direction drive assembly 232 with a drive member 2321, a gear 2322, and a rack 2323 and the drive member 2321 is set on the Y-direction movement mechanism 220, the gear 2322 is set on the output end of the drive member 2321, and the rack 2323 is set on the Z-direction movement member 2311 along the Z direction, and the gear 2322 meshes with the rack 2323; and
equipping both ends of each Y-direction movement assembly 221 of the Y-direction movement mechanism 220 with drive members 2321, which driving a gear 2322 to move on a rack 2323, so as to realize the movement of the Y-direction movement mechanism 220 on the Z-direction movement mechanism 230 in the Z direction;
avoiding interference between the two groups of first guide assembly 233 and facilitate assembly;
by providing Z-direction movement mechanism 230 with at least one group of first guide assembly 233, setting on the Z-direction movement member 2311, wherein the first guide assembly 233 is configured to provide guidance for the Y-direction movement mechanism 220 to move in the Z direction, so as to improve the stability of the Y-direction movement mechanism 220 moving in the Z direction, which is beneficial to avoid interference between the two groups of first guide assembly 233 and facilitate assembly and maintenance;
enhance the stability of the movement of the Y-direction movement mechanism 220 and avoiding jamming during movement, and thus improve the smoothness of the movement of the print head along the Z-axis;
providing at least two second working heads 300 on the X-direction movement assembly, perform simultaneous tasks like door and window repairs, plastering, or wall painting while the first printing head is printing;
after the printing is completed, disassembling the Z-direction movement member 2332 for storage or transport by disconnected the first brackets 2311a and prepare for changing construction sites or change in building requirements.

12. The method of claim 11, wherein the architecture is higher than 50 meters.

13. The method of claim 11, wherein the first bracket 2311a is made of carbon steel profile and surface is printed to prevent rust.

14. The method of claim 11, further comprising improving stability of the support system by arranging each set of Z-direction movement assemblies 231 comprising three Z-direction movement members 2311, which are parallel and spaced apart.

15. The method of claim 11, wherein the Z-direction drive assembly 232 with a drive member 2321, a gear 2322, and a rack 2323 and the drive member 2321 is set on the Y-direction movement mechanism 220, the gear 2322 is set on the output end of the drive member 2321, and the rack 2323 is set on the Z-direction movement member 2311 along the Z direction, and the gear 2322 meshes with the rack 2323.

16. The method of claim 11, wherein the first guide assembly 233 guide rail (2331) and guide member (a roller or a slider) which interacts with the guide rail to improve movement precision and stability.

17. The method of claim 11, wherein the detachable second brackets (2111) made of aluminum alloy.
